(19) United States
(12) Patent Application Publication
(10) Pub. No.: US 2005/0239211 A1
(43) Pub. Date: Oct. 27, 2005

(54) Concentration method and apparatus of preparing a liquid specimen for a trace element analysis system

(76) Inventors: Hiroshi Uchihara, Kyoto (JP); Masahiko Ikeda, Kyoto (JP); Atsushi Bando, Kyoto (JP)

Correspondence Address: Joseph W. Price;SNELL & WILMER, L.LP., Suite 1200, 1920 Main Street, Irvine, CA, 92614-7230, US

(21) Appl. No.: 11/085,365

(22) Filed: Mar. 21, 2005

(30) Foreign Application Priority Data
Mar. 31, 2004 (JP) 2004-105109

(51) Int. Cl. G01N 21/64

(52) U.S. Cl. 436/171; 436/174; 422/82.08

(57) ABSTRACT

The present invention provides a concentration method and apparatus for preparing a liquid specimen for a trace element analysis system. A holder positions a thin film that is prepared to have a liquid repellency so that a liquid sample containing a specimen can be uniformly evaporated to be concentrated at one location. An irradiation source of energy can be applied to enable a detector to determine the trace element.

### BACKGROUND OF THE INVENTION

1. Field of the Invention

The present invention relates to a system and method capable of concentrating a liquid specimen to realize a high sensitivity analysis for a trace element and analysis of the trace element contained in the liquid specimen by an element analyzer having an irradiation source with an energy of 1.24 eV or higher such as X-rays, laser beams or the like, including a fluorescent X-ray analysis method, a laser ablation/inductively coupled plasma mass spectrometry and the like.

2. Description of Related Art

An element analysis in a liquid specimen with a fluorescent X-ray analysis method, for example, has generally been conducted according to the following two methods; in one of which, as shown in FIG. 6(A), a specimen d is put in a vessel c dedicated to a liquid and constructed with a PET (polyethylene terephthalate) film a and a member b supporting the PET film in a state being stretched over an opening thereof and the specimen d is irradiated with X-rays from X-ray generating tube e through the lower surface of the vessel c to measure a fluorescent X-ray liberated from the specimen d in the vessel c with an X-ray detector f.

In the other method shown in FIG. 6(B), a liquid specimen is dropped onto a filter paper g, the dropped specimen is dried and thereafter the dried specimen d with which the filter paper g is impregnated is irradiated with X-rays to measure a fluorescent X-ray liberated from the specimen d.

In the former case, however, it is difficult to obtain sufficient sensitivity when a specimen concentration is low in the liquid carrier and in the latter case, scattering of X-rays (an influence of the background due to scattered X-rays) is caused by a material of the filter paper g to a great extent and the specimen d may not extend uniformly in the filter paper with local segregation, thereby causing a fluctuation in determined values.

Therefore, proposals have been made on a holding film for a specimen used in a fluorescent X-ray analysis method in Japanese Laid Open Application No. 3063934 including employing an organic thin film, much thinner than a conventional PET film of the smallest thickness, in a range of 1 to 3 μm that is available on the market. In the fabrication method for an organic thin film, a liquid specimen is dropped onto the organic thin film and left so as to extend by gravity, and then the specimen layer is evaporated to dry on the thin film and then used as an analysis specimen.

According to this method, a film thickness of the organic thin film holding the specimen is small, thereby enabling scattered X-rays serving as the background to be reduced.

The organic thin film, however, is not water repellent and when a liquid specimen is dropped onto the organic thin film, a water droplet of the liquid specimen is immediately widely spread over the surface of the thin film therealong with smoothness in a thin manner while keeping a circular outer periphery. Therefore, after the solvent is evaporated, a trace element (a component to be analyzed) contained in the liquid specimen is neither dispersed all over the circular area of the liquid specimen, nor flocculated and concentrated at one point, but the trace element (a component to be analyzed) is dotted like islands in the ocean on the organic thin film. Thus such a liquid specimen has not been able to be concentrated so as to enable a high sensitivity analysis for a trace element.

A liquid specimen can precipitate as crystals on a film in the course of concentration by evaporation of a solvent, which occurs according to the kind of a specimen, and the crystals can further act as obstacles hindering subsequent uniform reduction in the circular outer periphery accompanied by evaporation of the water droplet of the liquid specimen, thereby hindering concentration of the liquid specimen at one locatioin.

The present invention has been made in view of the above problems and it is an object of the present invention to enable a high sensitivity analysis for a trace element contained in a liquid specimen.

### SUMMARY OF THE INVENTION

In order to achieve the above object, the present invention includes the following technical features. That is, the invention is a system, apparatus and a concentration method for a liquid specimen used in an element analyzer having an irradiation source with energy of 1.24 eV or higher, where the liquid specimen is dropped onto a thin film of a water-repellent resin or an organic thin film coated with a water-repellent material, followed by concentration of the liquid specimen by evaporation of a solvent.

The thin film of a water-repellent resin employed can be a thin film of a fluorine-based resin, a silicone-based resin or the like with a smaller thickness than a conventional film being preferable. For example, a thin film of a PET film of a thickness of 5 μm or less is employed and a water-repellent material is used in coating the thin film such as a fluorine-based resin, a silicone-based resin or the like.

The invention includes a concentration method for a liquid specimen wherein a liquid paraffin or a surfactant is added to the liquid specimen, which is then dropped onto the thin film.

The invention also includes a holding tool to enable a concentration of the liquid specimen which is constructed with the thin film of a water-repellent resin or an organic thin film coated with the water-repellent material and a supporting member supporting the thin film when in a state of being stretched over an opening in the supporting member.

A fluorescent X-ray analysis method using the holding tool for concentrating the liquid specimen also can include the feature of the liquid specimen being dropped onto the thin film of a water-repellent resin or the organic thin film coated with a water-repellent material of the holding tool for concentrating the liquid specimen, the liquid specimen is concentrated by evaporation of the solvent, and the concentrated specimen is irradiated with X-rays to measure fluorescent X-rays liberated from the specimen and to thereby enable an analysis of a trace element contained in the specimen.

A laser ablation/inductively coupled plasma mass spectrometry can be used as the holding tool for concentrating the liquid specimen, wherein the liquid specimen is dropped onto the thin film of a water-repellent resin or an organic thin film coated with a water-repellent material of the holding tool for concentrating the liquid specimen, the liquid specimen is concentrated by evaporation of the solvent, and the concentrated specimen is irradiated with a laser beam to measure a gas component evaporated from the specimen and to thereby analyze a trace element contained in the specimen.

When the liquid specimen is dropped onto the thin film of a water-repellent resin or the organic thin film coated with a water-repellent material, the liquid specimen forms a thick water droplet on the surface of a film high in wafer-repellency by the action of a surface tension and the thick water droplet gradually decreases a diameter thereof by evaporation of a solvent to thereby flocculate and concentrate a trace element (a component to be analyzed) contained in the liquid specimen into one point. Evaporation can be accelerated by conventional procedures such as a heated clean gas. Therefore, at the final stage, the condensed specimen is obtained with a small spread but a relatively large density of trace element (in other words, high in concentration), which enables a high sensitivity analysis of a trace element contained in the liquid specimen to be conducted.

Even if a liquid specimen produces crystals in the course of concentration caused by evaporation of a solvent, liquid paraffin or a surfactant surrounds pieces of a material that crystallizes with ease to thereby disperse the pieces of a material in the liquid specimen; therefore, the crystals do not precipitate on the surface of a film till the last stage and no disturbance, to be otherwise caused by the crystals, affects uniform reduction of a diameter of the water droplet caused by evaporation of a solvent (concentration of the liquid specimen). Though the liquid paraffin or the surfactant remains at the last stage, atomic components of the liquid paraffin or the surfactant are known hydrogen, carbon, oxygen and the like, which will have no adverse influence on analysis of a trace element of another substance. Therefore, it is possible to conduct a high sensitivity analysis of a trace element contained in a liquid specimen that would be easy to form crystals accompanied by concentration caused by evaporation of a solvent.

According to the invention, the thin film of a water-repellent resin or an organic thin film coated with a water-repellent material is supported in a tension state over the opening of a support member, which can facilitate a series of operations from dropping of the liquid specimen to the concentration by evaporation of a solvent and the thus obtained condensed specimen as it is or together with a holding tool for concentrating a liquid specimen can also be loaded in an element analyzer with an X-ray or a laser as an irradiation source.

Since the liquid specimen containing a trace element is concentrated for analysis, a sufficient sensitivity is obtained despite an analysis on a liquid specimen containing a trace element and scattering of X-rays caused by a film thickness (an influence of the background due to scattered X-rays) is diminished, thereby enabling a high sensitivity analysis of a trace element to be realized.

According to the invention, the condensed specimen is irradiated with a laser beam and, then, the specimen is evaporated. Consequently, although the liquid specimen contains the trace element, a concentration of a gas component evaporated from the specimen becomes high, so that a high sensitivity analysis of a trace element can be realized.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a partially cutaway perspective view of a holding tool for facilitating concentration showing an embodiment of the present invention;

FIG. 2 is a schematically enlarged sectional view of a main part;

FIG. 3 is a perspective view of a holding tool for concentration showing another embodiment of a holding tool;

FIGS. 4A, 4(B) and 4(C) are descriptive schematics of a concentration method for a liquid specimen and a trace element analysis method;

FIGS. 5(A), 5(B), 5(C) and 5(D) are descriptive schematics of a concentration method for a liquid crystal specimen easy to be crystallized; and

FIGS. 6(A) and 6(B) are descriptive views of an element analysis method on a liquid specimen with a conventional fluorescent X-ray analysis method.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

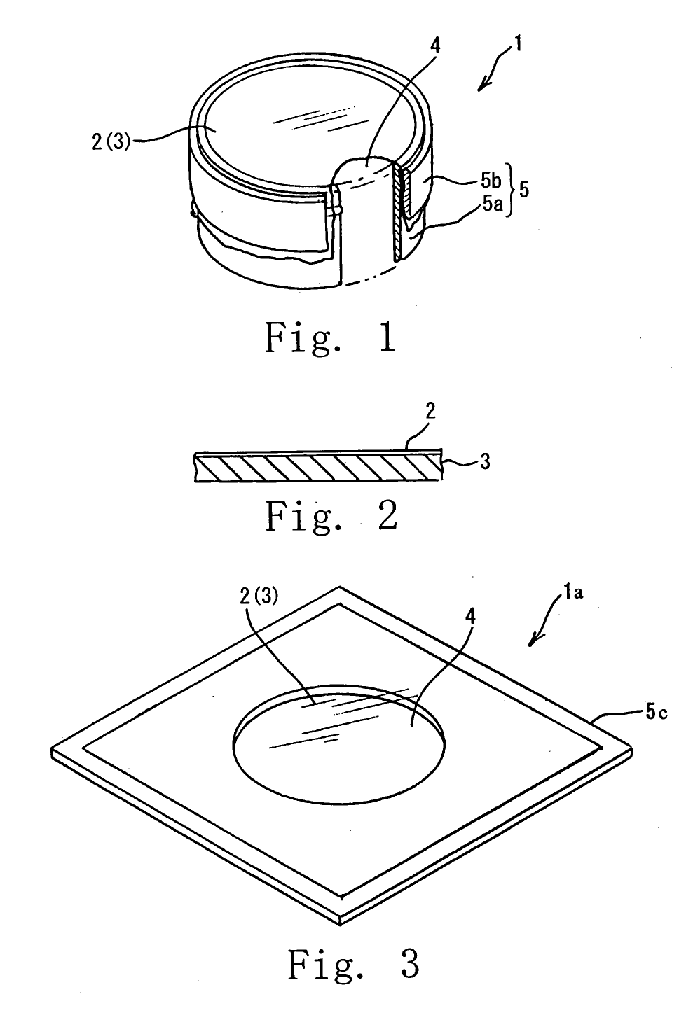

FIGS. 1 and 2 show an example of a holding tool 1 for concentrating a liquid specimen used in a system and concentration method for a liquid specimen containing a trace element according to the present invention. The holding tool 1 is constructed with an organic thin film 3 coated with a liquid-repellent material 2 and includes a supporting member 5 for supporting the organic thin film 3 in a state stretched over an opening 4. The supporting member 5 can include an inner ring 5a and an outer ring 5b, that can hold an outer peripheral portion of the thin film 3 therebetween to thereby support the thin film 3 in a state of tension to provide a flat plane surface to receive a liquid specimen. The inner ring 5a and outer ring 5b are concentric and of close dimensions to frictionally hold the thin film 3 between them.

The organic thin film 3 can be, for example, a PET film, a Nylon-based film or the like of a thickness of 5 μm or less. A water-repellent material 2 can be a fluorine-based resin or a silicone-based resin to provide a water-repellent film, thinner than the organic thin film 3, which is formed across the planar support surface of the organic thin film 3.

FIG. 3 shows an alternative example of a holding tool 1a for concentrating a liquid specimen according to the present invention. The holding tool 1a can be characterized by stretching an organic thin film 3 coated with water-repellent material 2 over a supporting member 5c in the shape of a flat plate having an opening 4a so as to cover the opening 4a. The other parts of a construction are the same as in the first embodiment shown in FIGS. 1 and 2.

Preferably there are two ways of coating the water-repellent material 2 on the organic thin film 3, in one case the organic thin film 3 is coated before being stretching over the supporting member 5 and in the other case water-repellent coating is applied after the organic thin film 3 is stretched over the supporting member 5. In each of the embodiments shown in FIGS. 1 and 3, a water-repellent material 2 is coated on one surface of an organic thin film 3 as shown in FIG. 2, however, the coating can be applied on both surfaces of the organic thin film 3 with the water-repellent material 2 and thereby the organic thin film 3 may be used regardless of a front surface or a rear surface.

A thin film of a water-repellent resin can be employed instead of an organic thin film 3 coated with a water-repellent material 2, and a holding tool 1 for concentrating a liquid specimen 1 may be constructed with the thin film of a water-repellent resin and the supporting member 5 for supporting the thin film in a state of being stretched over the opening 4. In this case, when the thin film of a water-repellent resin, employed is a thin film made of a fluorine-based resin or a silicone-based resin, the film thickness is preferably small in order to reduce scattering of X-rays caused by the film thickness (an influence of the background caused by scattered X-rays).

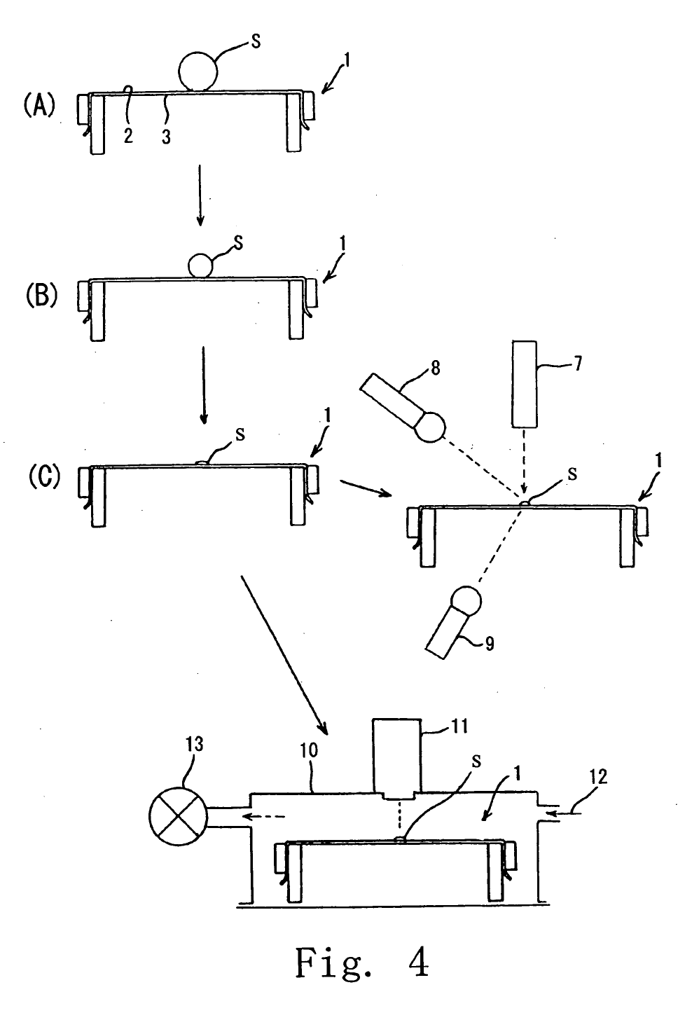

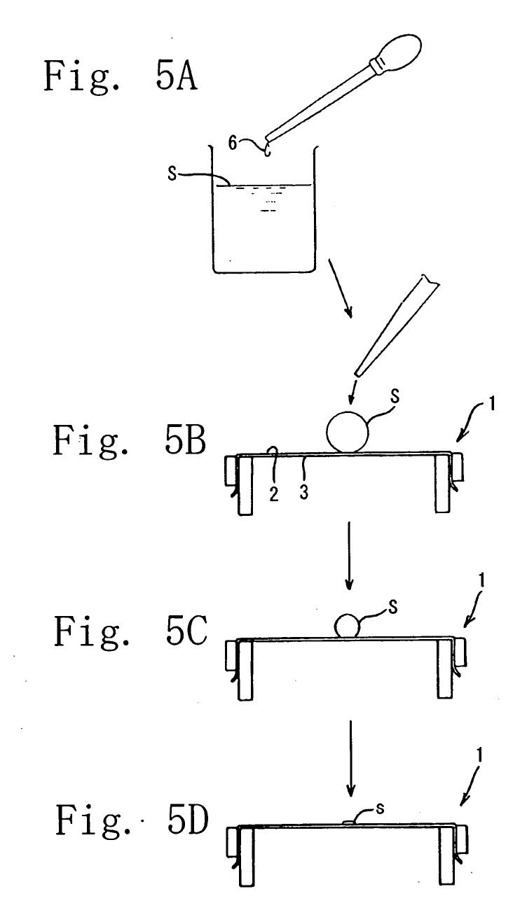

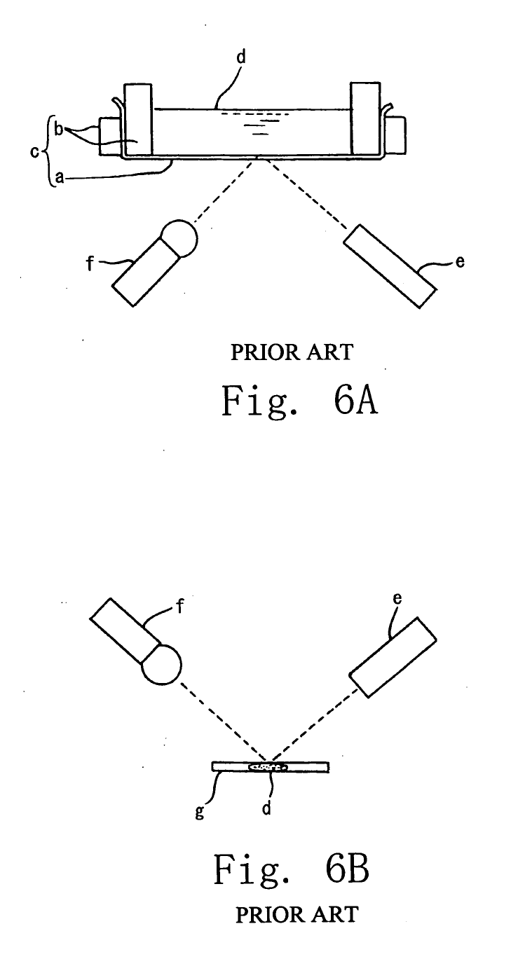

A description will now be given of a method and system for concentrating a liquid specimen containing a trace element according to the present invention based on FIGS. 4 and 5.

In concentration of a liquid specimen containing a trace element, the holding tool 1 shown in FIG. 1 (or FIG. 3) is used and when a liquid specimen S, using water as the carrier fluid, is dropped on a thin film of a water-repellent resin or an organic thin film 3 coated with a water-repellent material 2, the liquid specimen S can form a thick water droplet on a surface of the film that is high in water-repellency by the action of a surface tension of the liquid sample as shown in FIG. 4(A).

The water droplet, as shown in FIGS. 4(B) and 4(C), gradually decreases in diameter as a solvent is evaporated to thereby flocculate and concentrate a trace element (a component to be analyzed) contained in a liquid specimen S into one point and to then obtain, at the final stage, the condensed specimen S with a relatively small spread but a large density (in other words, high in concentration).

In a case of a liquid specimen S which is easy to be crystallized in the course of evaporation of a solvent, a trace (for example, so as to be a concentration of the order of 100 ppm) of a surfactant 6 is, as shown in FIG. 5(A), can be added to the liquid specimen S in advance, thereafter the liquid specimen S is, as shown in FIG. 5(B), dropped onto a thin film of a water-repellent resin or an organic thin film 3 coated with a water-repellent material 2 and the liquid specimen S then forms a thick water droplet, as shown in FIG. 5(B), by the action of a surface tension on a surface of a film high in water-repellency.

The water droplet, as shown in FIGS. 5(C) and 5(D), gradually reduces in diameter as the solvent evaporates (concentration), the surfactant 6 surrounds pieces of a material that are easy to be crystallized and disperses the pieces of a material in the liquid specimen S, which disables the material to be crystallized on the surface of a film till the last stage, so that no crystal formation will hinder a uniform reduction in diameter of the droplet in the course of evaporation of the solvent, and a trace element is flocculated and concentrated into one point, thereby enabling a condensed specimen S that is small in spread or diameter but large in thickness (in other words, high in concentration) to be obtained at the last stage. Though the surfactant 6 remains on the surface of a thin film until the last stage, atomic components of the surfactant 6 includes hydrogen, carbon, oxygen and the like, which does not affect an analysis of a trace element adversely.

Polyethylene glycol mono-p-isooctylphenyl ether, sorbitan mono-oleate and the like can be used as the surfactant 6. The same effect can be obtained even when liquid paraffin 6 is added instead of a surfactant 6, since liquid paraffin 6 surrounds pieces of a material which can be easily crystallized to thereby disperse the material into liquid specimen S.

The condensed specimen S obtained according to the above method is loaded together with the holding tool 1 in an element analyzer with an X-ray tube or a laser as an irradiation source for an analysis of a trace element. For example, in a case of a fluorescent X-ray analysis method, the condensed specimen S is held on the surface of a film of the holding tool 1, as shown in FIG. 4(C), and irradiated with X-rays emitted from the X-ray generating tube 7 to measure fluorescent X-rays liberated from the condensed specimen S. The fluorescent X-rays can contact an upper surface of X-ray detector 8 or a lower surface of an X-ray detector 9 to enable an analysis of a trace element contained in the specimen.

In such a manner, a liquid specimen S containing a trace element is concentrated and analyzed, and a sufficient sensitivity can be obtained. Even a liquid specimen S containing only a trace element can be analyzed since the scattering of X-rays caused by a film thickness (an influence of the background by scattered X-ray) is diminished, thereby enabling a high sensitivity analysis of the trace element to be achieved.

In a case of a laser ablation/inductively coupled plasma mass spectrometry, the condensed specimen S together with the holding tool 1 is, as shown in FIG. 4(C), loaded into an ablation cell 10, and the condensed specimen S held on the surface of a film of the holding tool 1 is irradiated with laser beam from a laser beam generator 11. A gas component is evaporated from the condensed specimen S by the impact of the laser beam and is sent to the detector 13 by a stream of a clear carrier gas (argon) 12 to enable an analysis of a trace element contained in the specimen.

Since a liquid specimen S containing only a trace element can be concentrated and the concentrated specimen irradiated with a laser beam to evaporate the specimen, a concentration of a gas component evaporated from the specimen is high despite applying an analysis on the liquid specimen S containing the trace element, thereby enabling a high sensitivity analysis of the trace element to be achieved.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

1. A concentration method for preparing a liquid specimen to be used in an element analyzer having an irradiation source with energy of 1.24 eV or higher, comprising;
providing the liquid specimen on a thin film of a water-repellent resin or an organic thin film coated with a water-repellent material, and
concentrating the liquid specimen by evaporation of a solvent in the liquid specimen.

2. The concentration method according to claim 1, wherein one of a liquid paraffin and a surfactant is added to the liquid specimen before concentrating the liquid specimen.

3. A holding tool for concentrating the liquid specimen used in the concentration method according to claim 1, comprising a supporting member supporting the thin film in a state of being stretched over an opening thereof.

4. A fluorescent X-ray analysis method using the holding tool for concentrating the liquid specimen described in claim 3, wherein the liquid specimen is dropped onto the thin film of a water-repellent resin or the organic thin film coated with a water-repellent material of the holding tool for concentrating the liquid specimen, and the concentrated specimen is irradiated with X-rays to measure fluorescent X-rays liberated from the specimen and to thereby analyze a trace element contained in the specimen.

5. A laser ablation/inductively coupled plasma mass spectrometry using the holding tool for concentrating the liquid specimen described in claim 3, wherein the liquid specimen is dropped onto the thin film of a water-repellent resin or the organic thin film coated with a water-repellent material of the holding tool for concentrating the liquid specimen, and the concentrated specimen is irradiated with a laser beam to measure a gas component evaporated from the specimen to thereby analyze a trace element contained in the specimen.

6. A thin film for supporting a liquid sample to be evaporated for condensing a specimen in the sample for X-ray analysis comprising;
a thin film of a material that will not scatter applied X-rays to the extent of interfering with an X-ray analysis of the specimen; and
a coating of a liquid repellant material on the thin film to cause a surface tension of the liquid sample to concentrate at one location on the thin film as it evaporates.

7. The thin film of claim 6 wherein the coating is a water-repellant material formed from one of a fluorine-based resin and a silicone-based resin and the thin film is formed of polyethylene terephthalate having a thickness of 5 μm or less.

8. An analysis system for concentrating and determining the elements in a specimen contained within a liquid sample comprising;
a support unit for receiving the liquid sample including a thin film of a material that will not scatter any applied X-rays to the extent of interfering with an X-ray analysis of the specimen, the thin film providing a planar surface with a liquid repellency to the liquid sample to cause the liquid sample to uniformly concentrate in one location on the thin film as it evaporates;
a solvent added to the liquid sample that will not scatter any applied X-rays to the extent of interfering with an X-ray analysis of the specimen;
means for evaporating the solvent in the liquid sample to enable a uniform concentration of the specimen on the support unit;
means for irradiating the concentrated specimen; and
means for detecting an element in the irradiated concentrated specimen.

9. The analysis system of claim 8 further including a surfactant added to the solvent.

10. The analysis system of claim 9 wherein the solvent is water.

11. The analysis system of claim 8 wherein the support unit includes a holder member having a pair of concentric rings for stretching the thin film.

12. The analysis system of claim 8 wherein the support unit includes a plate with a central opening for supporting the thin film.

13. The analysis system of claim 8 wherein the means for irradiating includes an X-ray generating tube and means for detecting includes an X-ray detector to measure fluorescent X-rays from the concentrated specimen.

14. The analysis system of claim 8 wherein the means for irradiating includes a laser beam generator for applying a laser beam to create a gas component representative of the specimen and the means for detecting includes a detector unit for receiving the gas component.

15. The analysis system of claim 8 wherein the thin film has a coating of a liquid repellant material on the thin film to cause a surface tension of the liquid sample to concentrate at one location on the thin film as it evaporates.

16. The analysis system of claim 15 wherein the coating is a water-repellant material formed from one of a fluorine-based and a silicone-based resin and the thin film is formed of polyethylene terephthalate having a thickness of 5 μm or less.

17. The analysis system of claim 8 further including a liquid paraffin added to the solvent.
